(19) United States
(12) Patent Application Publication
(10) Pub. No.: US 2026/0135020 A1
(43) Pub. Date: May 14, 2026

(54) LEAD-FREE POWER CABLE

(71) Applicant: NEXANS, Courbevoie (FR)

(72) Inventors: Oskar Leknes, Sperrebotn (NO); Henrik Lundeby Movinkel, Halden (NO); Audun Johanson, Oslo (NO); Øyvind Iversen, Ski (NO); Arild Hansen Sundnes, Sarpsborg (NO); Sigurd Schawlann, Son (NO); Gry Emilie Granstedt, Halden (NO); Anton Akulichev, HALDEN (NO)

(21) Appl. No.: 19/371,731

(22) Filed: Oct. 28, 2025

(30) Foreign Application Priority Data
Nov. 8, 2024 (NO) 20241108

(51) Int. Cl. H01B 13/00; H01B 7/18; H01B 7/282; H01B 13/24

(52) U.S. Cl. CPC H01B 13/0016; H01B 7/188; H01B 7/2825; H01B 13/24

(57) ABSTRACT

There is provided a method of manufacturing a power cable, the power cable including at least a cable core and a lead-free metallic water barrier surrounding the cable core, the method including heating at least a first portion of the lead-free metallic water barrier; surrounding the first portion of the lead-free metallic water barrier with a heat-activatable adhesive layer; and surrounding at least a portion of the adhesive layer with a reinforcement layer, where the adhesive layer adheres to the water barrier and to the reinforcement layer.

### FIELD OF THE INVENTION

The present invention relates to a method of manufacturing a lead-free cable as well as to a cable manufactured using said method. More specifically, the present invention relates to a method of manufacturing a subsea and/or high voltage cable that is lead-free.

### BACKGROUND

It is important to prevent water ingress into a subsea cable, and other cables subjected to potential humid environments, because water can damage the cable and particularly the insulation system of the cable. To prevent water ingress, a subsea cable may have a water barrier, which may be referred to as a water barrier layer, that surrounds the insulation system and the conductor of the cable.

Conventional cables use extruded lead, typically in the form of a lead sheath, as their water barrier. Lead sheaths are used in most subsea cable projects. Lead is a metal applicable as a radial water barrier because of its relatively low melting point, the metal is soft and has a high malleability. However, its toxicity and negative environmental effects encourage the industry to find alternative solutions. Furthermore, lead water barriers are not suitable for dynamic applications such as in relation to floating wind turbines or floating elements in the oil and gas industry such as floating field control stations for oil rigs. This is because the cable will experience frequent mechanical action under dynamic applications which can fatigue the lead water barrier. This fatigue may result in fracturing resulting in the ingress of water into the cable thus damaging the cable.

A lead-free power cable can be manufactured using a lead-free water barrier. However, lead-free water barriers cannot generally be formed by extrusion, in the way that standard lead water barriers can. Instead, a lead-free water barrier may be provided by forming a lead-free metallic sheet around a cable intermediate of a cable and then welding the sheet longitudinally where the two edges or ends of the metallic sheet meet. Such a cable can be susceptible to buckling either during the manufacturing process or during use (e.g. during bending and welding). Again, this buckling or other mechanical instabilities can be a particular problem when the lead-free power cable is used in dynamic applications.

There is a need for an improved method of manufacturing a lead-free power cable with improved mechanical properties, which is not susceptible to buckling or other mechanical instabilities, and which is suitable for dynamic applications such as in the context of floating objects (e.g. floating wind turbines and/or floating field control stations). Furthermore, there is need for such a method that is suitable for mass-manufacturing of lead-free power cables, e.g. suitable for a continuous manufacturing process.

The present invention attempts to address at least some of these points.

### SUMMARY OF THE INVENTION

The present invention is defined by the appended claims and in the following.

In a first aspect, the invention relates to a method of manufacturing a power cable comprising at least a cable core and a lead-free metallic water barrier surrounding the cable core.

The method comprises heating, such as pre-heating, at least a first portion of the lead-free metallic water barrier. The method comprises surrounding the first portion of the lead-free metallic water barrier with a hot-melt adhesive layer. The method comprises surrounding at least a portion of the adhesive layer with a reinforcement layer. The effect of this may be that the adhesive layer is activated (e.g. melted). The adhesive layer may adhere to the water barrier and the reinforcement layer.

In some embodiments, the method comprises providing the adhesive layer around the first portion of the water barrier after the first portion has been heated and while the water barrier remains hot from that heating process. In some embodiments, the first portion of the lead-free metallic water barrier may be heated after surrounding the first portion with the heat-activatable adhesive layer. In some embodiments, the first portion of the lead-free metallic water barrier may be heated after surrounding at least a first portion of the adhesive layer with the heat-activatable adhesive layer. Lead-free power cables can be manufactured using the method of the first aspect. The lead-free power cable comprises a reinforcement layer adhered to a lead-free metallic water barrier. The inclusion of the reinforcement layer can achieve desirable mechanical properties of the cable. The reinforcement layer can provide structural support to the water barrier and enhance the cable's durability more generally. For example, the risk of deformation and/or buckling of the lead-free water barrier (and/or the cable more generally) may be substantially reduced. However, the inventors have found that these desirable mechanical properties may only be achieved when there is good adherence between the reinforcement layer and the water barrier such that relative movement between the lead-free metallic water barrier and the reinforcement layer is minimised or eliminated. Suitable good adherence is achieved by the method of the present disclosure. This reduces the risk of buckling of the water barrier and minimises fatigue and the risk of fracturing in dynamic applications. Thus, the method of the present disclosure enables lead-free power cables to be manufactured that are suitable for dynamic applications.

In more detail, the inventors have found that the heating step (in which the water barrier may be heated prior to the provision of the adhesive layer and the reinforcement layer and/or during and/or after the provision of the adhesive layer and/or the reinforcement layer) may be needed to ensure proper activation of the heat-activatable adhesive layer. Without this heating (e.g. pre-heating) of the water barrier, there may not be enough heat energy to activate the adhesive layer properly and so good adhesion between the adhesive layer and the reinforcement layer might not be achieved. For example, it may be desirable for there to be good adhesion between all three layers (e.g. the water barrier, adhesive layer, and reinforcement layer). The inventors have found that this may be the case even when the method comprises forming the reinforcement layer and/or the adhesive layer using an extrusion process (such that the reinforcement layer and/or the adhesive layer are inherently provided significantly hotter than room temperature). The inventors have found that, even in this case, there is not enough heat energy in the system to properly activate the adhesive layer without (e.g. pre-)heating of the water barrier.

The method may not comprise heating the first portion of the water-barrier during and/or after the step of providing the adhesive layer and/or reinforcement layer. Prior to the provision of the adhesive layer and/or reinforcement layer it may be possible to monitor the temperature and/or condition of the water barrier. This may be to ensure that the water barrier does not overheat and/or is not damaged. After the provision of the adhesive layer and/or reinforcement layer, it may no longer be possible to monitor the temperature and/or condition of the water barrier. Therefore, it may be advantageous not to provide heating after the adhesive layer and/or reinforcement layer has been provided (i.e. after monitoring of the water barrier becomes impossible). This prevents unintentional unmonitored over-heating of the water barrier. Thus, the heating of the water barrier is preferably a pre-heating step (i.e. is performed prior to the step of providing the adhesive layer and/or the reinforcement layer). In other embodiments, the method may comprise heating the first portion of the water-barrier during and/or after the step of providing the adhesive layer and/or reinforcement layer.

As used herein, term “lead-free” may mean that the content of lead in the water barrier is below 10 wt.-%, preferably below 5 wt. %, preferably below 2 wt. %, preferably below 1 wt. %, preferably below 0.5 wt. % based on the total weight of the metal or metal alloy. The water barrier is lead-free because the water barrier should be made of a metal or metal alloy substituting lead as the material used in the state of the art as water barriers for subsea electric cables.

As used herein, the “hot-melt” adhesive may be referred to as a heat-activatable adhesive.

As used herein, the term “hot-melt” in the context of an adhesive means that heat is required to initiate or enhance the bonding properties of the adhesive. For example, when heat is applied, that heat may cause a chemical reaction or physical change in the adhesive. For example, this may allow the adhesive to flow and/or to cure more effectively. A hot-melt adhesive may have an activation temperature. The activation temperature may be the threshold temperature that the adhesive is designed to become effective. For example, the activation temperature may need to be reached or exceeded to activate (e.g. melt) the adhesive.

The method may be continuous. The steps of the method may be carried in sequential order. For example, the method may comprise heating the first portion of the lead-free metallic water barrier; and then surrounding that first portion of the lead-free metallic water barrier with a hot-melt adhesive layer; and then surrounding at least a portion of the adhesive layer with a reinforcement layer such that the adhesive layer adheres to the water barrier (in particular, the first portion of the water barrier) and the reinforcement layer.

The method may comprise surrounding a first portion of the lead-free metallic water barrier with a hot-melt adhesive layer; and then heating the first portion of the lead-free metallic water barrier; and then surrounding at least a portion of the adhesive layer with a reinforcement layer such that the adhesive layer adheres to the water barrier (in particular, the first portion of the water barrier) and the reinforcement layer.

The method may comprise surrounding a first portion of the lead-free metallic water barrier with a hot-melt adhesive layer; and then surrounding at least a portion of the adhesive layer with a reinforcement layer; and then heating the first portion of the lead-free metallic water barrier such that the adhesive layer adheres to the water barrier (in particular, the first portion of the water barrier) and the reinforcement layer. Unlike lead water barriers, non-lead water barriers may not be suitable for extrusion. Instead, the non-lead water barrier may be a welded sheet such as a longitudinally welded sheet. Thus, the method may comprise forming a lead-free metallic sheet around a cable intermediate and welding the sheet. The forming may comprise bending the lead-free metallic sheet. The weld may be a longitudinal weld. The weld may be where the two edges or ends of the metallic sheet meet.

In some embodiments, the reinforcement layer may be a jacket. The jacket may comprise a polymer. In such cases, the reinforcement layer may be referred to as a polymer jacket. The reinforcement layer may comprise a polymer such as polyethylene, high-density polyethylene (HDPE), Medium-Density Polyethylene (MDPE), Low-Density Polyethylene (LDPE), or Linear Low-Density Polyethylene (LLDPE). The reinforcement layer may comprise a halogen-free flame-retardant material. The reinforcement layer may be electrically insulating. In other words, the reinforcement layer may be referred to as an isolated or isolating reinforcement layer. In some embodiments, the reinforcement layer may be semiconducting. The reinforcement layer may comprise carbon black.

In some embodiments, the heating comprises heating with at least one of a first heating source and a second heating source. The first heating source may be a different type of heating source to the second heating source. In other words, the heating may comprise heating with at least one of a first heating source and a second heating source.

As used herein, a type of heating source may refer to the specific method or mechanism used to generate heat. For example, a first type of heating source may heat according to an inductive principal and a second type of heating source may heating according to a convective principal. The method may comprise heating with a plurality of heaters of the same type of heater. For example, the method may comprise heating the water barrier using a plurality of individual or discrete convection heaters surrounding at least a portion of the water barrier. All of the plurality of convections heaters may be described as being of the same type.

The primary heating source may comprise one or more induction heating coils. The method may comprise passing an alternating current through the one or more induction heating coils. This may generate an oscillating electromagnetic field around the one or more coils. Therefore, heating the water barrier may comprise inductive heating of the water barrier. In other words, the primary heating source may be inductive heating type heating source. The primary heating source may be arranged to inductively heat the lead-free water barrier. Heat may then be transferred from the water barrier to the adhesive layer by conduction, for example, once the adhesive layer has been provided on the water barrier. In some embodiments, one or more induction heating coils are positioned around at least a portion of the water barrier layer during at least part of the heating step.

In embodiments in which the primary heating source is induction-based, it is advantageous that the non-lead water barrier is electrically conductive. More specifically, it may be advantageous that the non-lead water barrier is metallic and so may be electrically conductive. In this way, when the water barrier is in the vicinity of the one or more induction heating coils, and an alternating current is passes through the one or more induction coils, electrical currents may be induced in the water barrier due to the changing magnetic field. These induced currents may generate heat. Heat may be generated due to the electrical resistance of the water barrier.

In some embodiments, the secondary heating source may comprise one or more convection heaters. The one or more convection heaters may be arranged to output heated air. The one or more convection heaters may be arranged such that the heated air flows towards and/or over the water barrier. Heating the water barrier may comprise convection heating of at least a portion of the water barrier.

In some embodiments, the heating (e.g. preheating) comprises heating with both the first and second heating sources. The inventors have found that the combination of the first and second heating sources (each being a different type of source) may be particularly advantageous to allow for greater control of the amount of heat energy during the heating step (vs. using only a single type of heater).

If too little heat energy is provided during the heating step, then the adhesive layer may not be activated and/or may not remain activated during the step of providing the reinforcement layer. The latter may be particularly relevant in a continuous process which comprises heating the water barrier as a cable intermediate passes the heating sources and then moving the heated portion of the water barrier past an adhesive layer applicator and/or a reinforcement layer applicator such as an extruder. As soon as the heated portion of the water barrier moves away from the heat source, it may cool down. If the water barrier cools down too much, then proper adhesion between the water barrier and polymer jacket may not be achieved.

If too much heat energy is provided during the heating step, then the cable/cable intermediate may be damaged by the heating. For example, inner layers of the cable intermediate such as insulation layers may be damaged. Alternatively, or additionally, if heat is supplied too fast then there may be expansion of the water barrier which might adversely affect the mechanical properties of the cable.

By providing primary and secondary heating sources of different types, the controllability of the supply of heat energy during the heating step may be improved.

As used herein, a “cable intermediate” refers to features of a partially manufactured cable. The method of the present disclosure may comprise providing a water barrier assembly that surrounds the cable intermediate. The water barrier assembly may comprise the water barrier, the adhesive layer, and the reinforcement layer.

In some examples, the cable intermediate may comprise or consist of a cable core comprising a conductor core and an insulation system surrounding the conductor core. The cable core may be referred to as power phase. When the cable intermediate comprises or consists of a cable core or power phase, the method of the present disclosure may comprise providing a water barrier assembly that surrounds the cable core or power phase.

In some embodiments, the cable intermediate may comprise a plurality of cable cores or power phases (e.g. the cable intermediate may be for a three-phase system and so comprise three individual power phases or cores).

In some embodiments, the method comprises feeding a cable intermediate comprising a lead-free metallic water barrier layer through a manufacturing line such that the cable intermediate passes: the primary and/or secondary heating source to heat the adhesive layer; and then an adhesive applicator; and a reinforcement layer applicator. The method may be continuous. The adhesive applicator may be arranged to surround at least a portion of the water barrier with the hot-melt adhesive layer. The reinforcement layer applicator may be arranged to surround at least a portion of the adhesive layer with a reinforcement layer. The adhesive applicator may be arranged to extrude the adhesive layer. In other embodiments, the adhesive layer may be provided as a tape and the adhesive applicator may be arranged to wind the tape around the water barrier. This may be in an overlapping fashion. In some embodiments, the reinforcement layer applicator may be arranged to extrude the reinforcement layer. In such embodiments, surrounding the adhesive layer with the reinforcement layer may comprise extruding polymer material around the adhesive layer. In embodiments where the adhesive layer and the reinforcement layer are extruded, the manufacturing line may be arranged such that the adhesive layer and the reinforcement layer may be co-extruded. In other words, the method may comprise co-extruding the adhesive layer and the reinforcement layer. In such embodiments, the steps of providing/surrounding with the adhesive layer and reinforcement layer may be performed substantially simultaneously.

In some embodiments, the method comprises heating the first portion of the water barrier to a temperature greater than or equal to 70 degrees Celsius, optionally greater than or equal to 100 degrees Celsius, optionally greater than or equal to 130 degrees Celsius, optionally greater than or equal to 140 degrees.

In some embodiments, the method comprises heating the first portion of the water barrier to a temperature less than or equal to 450 degrees Celsius, optionally less than or equal to 350 degrees Celsius, optionally less than or equal to 300 degrees Celsius.

In some embodiments, the method comprises heating the first portion of the water barrier for at least 3 seconds, optionally at least 10 seconds, optionally at least 20 seconds. In some embodiments, the method comprises heating the first portion of the water barrier for 300 seconds or less.

In some embodiments, the water barrier comprises or consists of at least one of tin, brass, bronze, titanium indium, zinc, bismuth, tellurium, copper, copper alloy, tin, zinc or aluminium. The water barrier may comprise or consist of a copper alloy, stainless steel, or an aluminium alloy. The water barrier may comprise at least one of the following alloys: copper nickel, copper silicon, copper nickel silicon, or copper cobolt phosphorous.

The water barrier may preferably be a copper nickel alloy or a copper silicon alloy. The copper nickel alloy may comprise a 0% to 100% copper and/or 100% to 0% nickel; optionally 1% to 100% copper and/or 100% to 1% nickel; optionally 5% to 100% copper and/or 100% to 5% nickel; optionally 10% to 100% copper and/or 100% to 10% nickel. The copper silicon alloy may comprise a 0% to 100% copper and/or 100% to 0% silicon; optionally 1% to 100% copper and/or 100% to 1% silicon; optionally 5% to 100% copper and/or 100% to 5% silicon.

The water barrier may be electrically conductive. The water barrier may have an electrical conductivity of 1 Megasiemans per meter or greater, optionally 5 Megasiemans per meter or greater, optionally 10 Megasiemans per meter or greater.

In some embodiments, the hot-melt adhesive comprises Yparex® or Premix PRE-ELEC® PE19739.

In some embodiments, the cable manufactured by the method is a subsea cable. This may mean that the cable is specifically designed to operate and transmit signals or power when the cable is beneath the water, i.e. when wholly or partially submerged in water. The skilled reader will be familiar with the properties of cables that are suitable for subsea operation. This may mean that the subsea cable has suitable insulation and protection against water ingress while maintaining electrical integrity (hence the presence of the water barrier layer in the cable). This may mean that the subsea cable has layers providing strength and durability to withstand the mechanical stresses associated with installation, seabed conditions, and potential movements caused by tides and currents. The water that the cable is arranged to be submerged in may be salt-water or fresh-water.

In some embodiments, the cable manufactured by the method is a “high-voltage” cable. This may mean that the cable is specifically designed to transmit currents at voltages that are higher than typical or standard voltage levels and do so efficiently and without damaging the cable. The skilled reader will be familiar with what constitutes a high voltage. For example, high-voltage levels can range from several kilovolts (kV) to megavolts (MV). For example, high voltage may mean 25 kV or above, 100 kV or above, 500 kV or above, or 1 MV or above. The skilled reader will also be familiar with the features of a cable making it suitable for high-voltage transmission. This includes having suitable insulation to prevent electrical breakdown and thermal stability to withstand heat that may be generated during high-voltage transmission.

In a second aspect, there is provided a cable comprising a reinforcement layer around a lead-free metallic water barrier, the reinforcement layer being adhered to the water barrier by an adhesive layer. The cable of the second aspect may be obtained or obtainable by the method of the first aspect.

Features and advantages described in relation to the first aspect may be applicable to the second aspect, and vice versa.

### SHORT DESCRIPTION OF THE DRAWINGS

In the following description this invention will be further explained by way of exemplary embodiments shown in the drawings, in which:

FIG. 1 is a cross-sectional schematic view of a first example of a high-voltage subsea cable comprising a single core manufactured according to the present disclosure;

FIG. 2 is a schematic view of a continuous manufacturing line for performing a manufacturing method according to the present discourse; and

FIG. 3 is a flow diagram of a method according to the present disclosure.

### DETAILED DESCRIPTION OF THE INVENTION

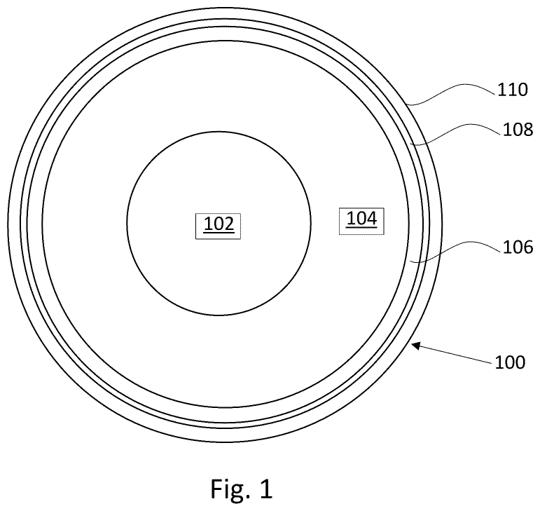

FIG. 1 shows a cross-sectional schematic view of a first example of a high-voltage subsea cable 100 manufactured using a method according to the present disclosure. The cable 100 comprises a single core (represented by reference numerals 102 and 104 in FIG. 1). The single-cored cable 100 comprises a conductor or conductive core 102 comprising or consisting of an electrically conductive material (e.g. metal such as copper). In examples, the conductor 102 comprises a plurality of individual conductive strands or wires. The conductor 102 is surrounded by an insulating system 104 in some examples. The insulating system may comprise multiple layers. For example, the system may comprise a first or inner semi-conductive layer, then an insulating layer, and then a second or outer semi-conductive layer. The insulating system 104 is surrounded by a water-barrier layer 106. In this example, the water barrier layer 106 is metallic and lead-free. In this example, the water barrier layer 106 comprises CuNi₂₅. The water barrier layer is electrically conductive and is arranged to provide a water-tight seal around the insulating system 104/conductor 102 to prevent the ingress of water and to prevent water treeing in the insulating system 104. The water barrier layer 106 is surrounded by an adhesive layer 108 which, in turn, is surrounded by a reinforcement layer which in this example is a polymer jacket 110. The adhesive layer 108 is adhered to the water barrier layer 106 and to the polymer jacket 110. In this way, relative movement between portions of the polymer jacket 110 and portions of the water barrier layer 106 is prevented. This has the effect of reducing the risk of buckling of the water barrier layer 106 and making the cable 100 suitable for use in dynamic uses cases such as in relation to floating objects (e.g. floating wind turbines).

Although not shown in FIG. 1, the cable 100 may comprise one or more layers such as a protective and/or armoured layer that is arranged to provide protection to the cable to prevent damage when the cable 100 is laid and/or is otherwise dragged along the sea floor.

FIG. 1 is an example of a cable comprising a single core. However, the method of the present disclosure is suitable for the manufacture of multi-core cables (e.g. three-phase cables) too. In such examples, each individual core of the multi-core cable may comprise a water barrier layer, adhesive layer, and polymer jacket. Alternatively, or additionally, a water barrier layer, adhesive layer, and polymer jacket may surround the multi-core cable as a whole.

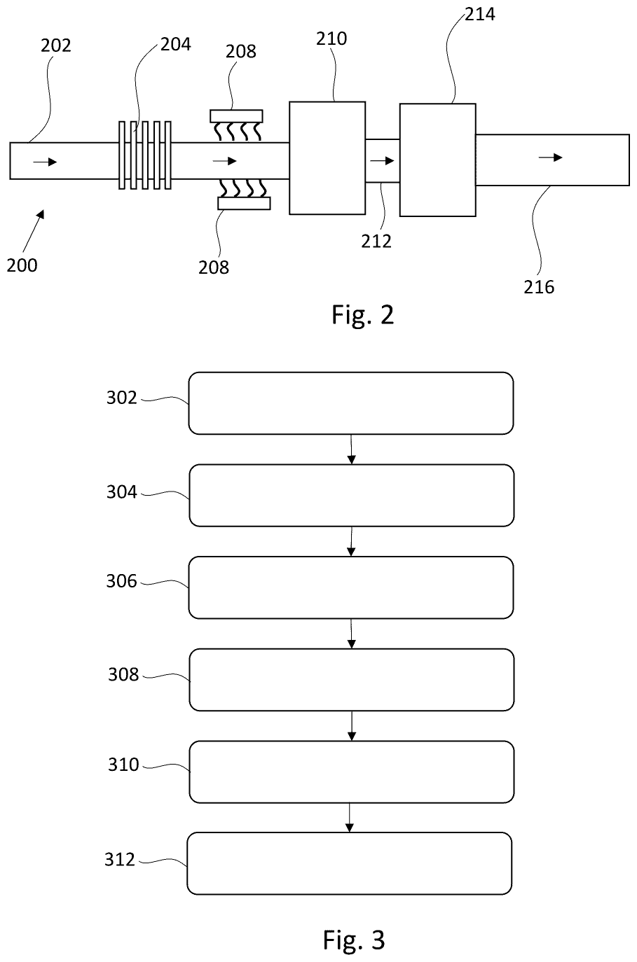

FIG. 2 is a schematic view of features of a manufacturing line 200 for carrying out the method of the present disclosure and so is suitable for manufacturing the cable 100 of FIG. 1 (at least in-part).

The manufacturing line 200 comprises a primary heating source 204 which, in this example, is an inductive heater comprising a plurality of inductor coils. FIG. 2 shows an induction heater comprising five coils. However, it should be understood that this is merely exemplary. There may be any number of coils and many examples will comprise an induction heater comprising many more than five coils. The manufacturing line 200 comprises a plurality of secondary heating sources 208 which, in this example, are each convection heaters arranged to output hot air. Two secondary heating sources 208 are shown in FIG. 2 however there may be any number of secondary heating sources 208. The or each of the secondary heating sources 208 may be arranged around a region for receiving a workpiece to be heated (e.g. a cable core).

In some examples, the primary and second heating sources 204, 208 may be reversed. In some examples, the primary and second heating sources 204, 208 may be integrated together into a single heating system which is arranged to heat by convection and induction substantially simultaneously.

The manufacturing line 200 comprises an adhesive applicator 210 which, in this example, is arranged to provide an adhesive layer by extrusion. In other examples, the adhesive applicator may be arranged to provide an adhesive layer by winding an adhesive tape, optionally in an overlapping fashion. The manufacturing line comprises a polymer jacket applicator 214 which, in this example, is arranged to provide a polymer jacket by extrusion.

Although the adhesive applicator 210 and polymer jacket applicator 214 are shown as separate features in FIG. 2, in some examples the adhesive applicator 210 and the polymer jacket applicator 214 are provided substantially together (i.e. are integrated with one another). For example, an integrated adhesive applicator 210 and polymer jacket applicator 214 may be arranged to co-extrude an adhesive layer surrounded by a polymer jacket.

FIG. 3 is a flow diagram representing the steps of the method according to the present disclosure. In summary, the method comprises passing a cable core already comprising the non-lead water barrier through the manufacturing line 210 substantially continuously such that the non-lead water barrier layer is heated by the primary and second heating sources 204, 208 and then an adhesive layer is applied to water barrier layer followed by a polymer jacket. The method will now be described in more detail.

Step 302 of the method according to the present disclosure comprises providing a cable core surrounded by an electrically conductive, non-lead, metallic water barrier layer 202. The cable core is substantially continuous. Step 302 comprises substantially continuously feeding the cable core (surrounded by the water barrier layer 202) into the manufacturing line 200. In FIG. 2, this results in the cable core (with water barrier layer 202) moving from left to right through the manufacturing line 202 and this movement is represented by the arrows in FIG. 2.

Step 304 of the method comprises inductively heating a first portion of the water barrier layer 202 as the water barrier layer moves past the primary heating source 204. The induction coils of the primary heating source 204 surround the first portion of the water barrier layer 202 during step 304. Furthermore, during step 304, an alternating current is supplied to the induction coils of the primary heating source 204. This creates an oscillating electromagnetic field around the coils. As above, the water barrier layer 202 is electrically conductive. Therefore, electrical currents are induced (by the oscillating field) in at least the first portion of the water barrier layer 202. Heat is generated in first of the water barrier layer 202 as a result of Joule heating (i.e. resistive heating).

The first portion of the water barrier layer 202 then moves from the primary heating source 204 towards the secondary heating source 208. Step 306 of the method comprises convection heating the first portion of the water barrier layer 202 using convection heaters 208. The convection heaters 208 are arranged to blow hot air onto the first portion of the water barrier layer 202 as the first portion passes the convection heaters 208.

Steps 304 and 306 of the method may be reversed in some examples.

Steps 304 and 306 of the method may be performed substantially simultaneously in some examples. In such examples, the first portion may not need to move between the primary heating source 204 and the secondary heating source 208.

After step 306, the first portion of the water barrier layer 202 (now heated) then moves to the adhesive layer applicator 210. Step 308 of the method then comprises extruding an adhesive layer 212 such that the adhesive layer surrounds the first portion of the water barrier layer 202. This is done immediately following step 304 such that the first portion of the water barrier layer 202 remains hot. The adhesive layer 212 is heat-activatable or a hot-melt adhesive layer. The activation temperature of the heat-activatable adhesive layer is 130 degrees in this example. In this example, the adhesive layer 212 comprises Yparex.

After step 308, the first portion of the water barrier layer 202 (now heated and surrounded by an adhesive layer 212) then moves to the polymer jacket applicator 214. Step 310 of the method then comprises extruding a polymer jacket 216 such that the polymer jacket surrounds adhesive layer 212 (which is surrounding the first portion).

After step 310, the first portion of the water barrier layer 202 (now surrounded by an adhesive layer and then a polymer jacket) moves away form the polymer jacket applicator 214. During step 312, the adhesive layer 212 is allowed to cure. This provides adhesion between the polymer jacket 216 and the water barrier layer 202 and prevents relative movement between the two. As described above, this means that the cable is suitable for dynamic uses cases and can undergo frequent and/or continuous mechanical action without failure of the water barrier layer 202.

The purpose of the heating (or pre-heating) of steps 304 and 306 is to ensure that the adhesive layer 212 is raised to at least its activation temperature. Without the heating of steps 304 and 306, there would not be enough heat energy in and around the first portion of the water barrier layer 202 to ensure sufficient activation of the adhesive layer 212. In this example, after steps 304 and 306, the first portion of the water barrier layer 202 will have been heated to a temperature of at least 70 degree Celsius but less than 450 degrees Celsius (e.g. 200 degrees Celsius). In this example, the first portion of the water barrier layer 202 is heated for at least 20 seconds but less than 300 seconds (e.g. 60 seconds). The inventors have found that this ensures that a) there is enough heat energy in and around the first portion to activate the adhesion layer; b) the cable core does not become overheated and damaged; and c) the water barrier layer 202 is not heated too quickly which can otherwise cause swelling.

Optionally, after step 312, the method may, comprise moving the first portion of the water barrier layer 202 to another manufacturing or to another component of the same manufacturing line. For example, the method may optionally comprise applying an armouring layer which surrounds the polymer jacket 216.

Optionally, prior to step 302, the method may comprise surrounding at least the first portion of the cable core with the first portion of the water barrier layer 202. This may comprise bending a lead-free metallic sheet around the first portion of the cable core such that the first portion of the cable core is surrounded by the lead-free metallic sheet with the two edges of the metallic sheet meeting longitudinally with respect to the length of the cable core. The method may then comprise longitudinally welding the two edges of the metallic sheet. These optional steps may be performed on the same manufacturing line 200 as shown in FIG. 2, or in a separate manufacturing line.

The method has been described above in terms of a single (first) portion of the cable core or water barrier layer passing through the manufacturing line 200. This is to illustrate the processes that happen to that portion in order. However, it should be understood that the manufacturing line 200 of FIG. 2 allows for continuous manufacturing and that all of the processes described may therefore be occurring simultaneously to different portions of a cable core. For example, while the first portion is being heating, a second portion of the water barrier layer downstream of the first portion may be being surrounded by an adhesive layer and a third portion of the water barrier layer downstream of the second portion may be being surrounded by a polymer jacket.

### LIST OF REFERENCE NUMERALS

100—power cable (manufactured according to method)
102—conductor
104—insulating system
106—lead-free metallic water barrier
108—adhesive layer
110—polymer jacket
200—manufacturing line
202—water barrier (surrounding cable core)
204—primary heating source (induction coil)
208—secondary heating source (convection heaters)
210—adhesive applicator
212—adhesive layer (surrounding water barrier)
214—polymer jacket applicator
216—polymer jacket (surrounding adhesive layer)

1. A method of manufacturing a power cable, the power cable comprising at least a cable core (102,104) and a lead-free metallic water barrier surrounding the cable core, wherein the method comprises the steps of:
heating at least a first portion of the lead-free metallic water barrier;
surrounding the first portion of the lead-free metallic water barrier with a hot-melt adhesive layer; and
surrounding at least a portion of the adhesive layer with a reinforcement layer such that the adhesive layer adheres to the water barrier and the reinforcement layer.

2. The method of claim 1, wherein the method comprising forming a lead-free metallic sheet around a cable intermediate comprising a cable core and welding the sheet.

3. The method of claim 1, wherein the heating comprises heating with at least one of a first heating source and a second heating source, the first heating source being of a different type of heating source to the second heating source.

4. The method of claim 3, wherein the primary heating source comprises one or more induction heating coils.

5. The method of claim 4, wherein the one or more induction heating coils are positioned around the first portion of the water barrier during at least part of the heating step.

6. The method of claim 1, wherein the secondary heating source comprises one or more convection heaters.

7. The method of claim 1, wherein the heating comprises heating with both the first and second heating sources.

8. The method of claim 2, wherein the method comprises feeding a cable intermediate comprising the water barrier through a manufacturing line such that the cable intermediate passes:
the primary and/or secondary heating source to heat the first portion of the water barrier;
an adhesive applicator arranged to surround the first portion of the water barrier with the adhesive layer; and
a reinforcement layer applicator arranged to surround at least a portion of the adhesive layer with the reinforcement layer.

9. The method of claim 1, wherein surrounding the adhesive layer with the reinforcement layer comprises extruding polymer material around the adhesive layer.

10. The method of claim 1, wherein the method comprises heating the first portion of the water barrier to a temperature greater than or equal to 70 degrees Celsius.

11. The method of claim 1, wherein the method comprises heating the first portion of the water barrier to a temperature less than or equal to 450 degrees Celsius.

12. The method of claim 1, wherein the method comprises heating the first portion of the water barrier for at least 3 seconds.

13. The method of claim 1, wherein the method comprises heating the first portion of the water barrier for 300 seconds or less.

14. A cable comprising a reinforcement layer around a lead-free metallic water barrier, the reinforcement layer being adhered to the water barrier by an adhesive layer, wherein the cable is obtained by the method of claim 1.
